(19) United States
(12) Patent Application Publication
(10) Pub. No.: US 2007/0092409 A1
(43) Pub. Date: Apr. 26, 2007

(54) Reconfigurable valve using optically active material

(76) Inventors: Christopher C. Beatty, Albany, OR (US); Philip Harding, Albany, OR (US); Andy Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/255,336

(22) Filed: Oct. 21, 2005

(51) Int. Cl. B01L 3/00

(52) U.S. Cl. 422/100

(57) ABSTRACT

A microfluidic device includes a microfluidic coupon and at least one fluid channel associated with the microfluidic coupon. The fluid channel is configured to control fluid flow from one portion of the coupon to another portion of the coupon. A quantity of reconfigurable valving material is disposed within the fluid channel, the valving material being thermally coupled to an optically activatable material operable to increase a temperature of the valving material when exposed to an optical beam to at least partially soften at least one component of the valving material to allow reconfiguration of the valving material to switch a flow state of the fluid channel.

### FIELD OF THE INVENTION

The present invention relates generally to valves and valving systems for controlling fluids.

### BACKGROUND OF THE INVENTION

Microfluidic devices have been used in a variety of technical applications, including medical treatment and testing regimes, industrial control processes, ink-jet applications, chemical and biological processes, biomedical analyses, micro-chemical reactions, etc. In particular, chemical processes and analyses have been developed that rely upon microfluidic transport mechanisms to manipulate fluid in a particular timing and sequencing regime to achieve precise analysis in chemical assays. In many of these processes, implementation of microfluidic devices is desirable to mix, react, measure, separate, dilute, and/or transport small volumes of fluid. As such, there has been increased interest in and research related to developing microfluidic devices that are able to controllably manipulate fluid flow.

A number of approaches have been developed for modulating and manipulating microfluidic flow. One such approach is applying mechanical valves or devices to either induce or impede fluid flow in microfluidic channels. For example, an electromechanical or pneumatic-mechanical microfluidic actuator or solenoid has been employed in some micro-channeling systems to manipulate and deliver desired fluids to micro-technology systems. However, there are several disadvantages that arise when utilizing micro-mechanical valves. For example, mechanical valves generally involve sophisticated, micro-scale moving parts which are costly to manufacture and susceptible to wear, reliability, and longevity issues.

Another type of valve or device often incorporated into microfluidic technologies is the electronic actuated valve. Normally, these types of valves, such as piezoelectric actuated micro-valves, lack small moving parts. The piezoelectric micro-valve generally includes several piezoelectric disks stacked and in communication with a flexible diaphragm. To cause the diaphragm to expand or contract, voltage is applied across the stack of piezoelectric disks, resulting in the stack contracting into a compressed condition, which in turn lifts the diaphragm, thereby creating a narrow opening in a microfluidic channel. While such piezoelectric disks have been used with some success, they are generally overly complex and not particularly cost efficient.

A simpler type of valve has been developed that utilizes wax that is positioned into a channel or conduit to provide blockage or restriction of fluid flow in the channel. In order to obtain fluid flow, the wax material is heated and liquefied, clearing the channel and allowing fluid flow through the channel. This type of fluid flow manipulation does not require moving parts; however, it has required the presence of electric heating strips on the body housing the channel or conduit, which must be powered and controlled through conventional circuitry. These types of circuits are difficult to incorporate effectively into microfluidic systems.

Thus, in spite of numerous efforts to address controllable manipulation of fluids in various microfluidic applications, there exists still a need for a microfluidic valving device that is simple and effective for broad use in microfluidic applications.

### BRIEF DESCRIPTION OF THE DRAWINGS

FIG. 1 is a perspective, top edge view of a microfluidic test coupon in accordance with an embodiment of the present invention;

FIG. 2 is a top view of a section of the test coupon of FIG. 1;

FIG. 3A is a top view of a portion of a microfluidic channel in accordance with an aspect of the invention; and

FIG. 3B is a top view of a portion of another microfluidic channel in accordance with an aspect of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used:

The singular forms “a,” “an,” and “the” include plural referents unless the context clearly dictates otherwise.

As used herein, the terms “microfluidic coupon” or “coupon” are to be understood to refer to a device used to manipulate, e.g., such as by centrifugation or other forces, one or more microfluids, generally for the purposes of testing the fluid or liquid. Microfluidic coupons utilized in the present invention can include, but are not limited to, disk-shaped devices formed of poly(methylmethacrylate) (PMMA), acetonitrile-butadiene-styrene (ABS), polystyrene, polycarbonate, etc. While not so limited, such disks can be similar in appearance to well-known compact disks (CDs) and can utilize centrifugal and capillary forces to move fluids. Other coupons can also be used that are not rotationally configured, such as those where fluid flow is effectuated using other forces, e.g., thermal jetting, piezoelectric, pneumatic, electrophoretic, etc.

As used herein, the term “reconfigurable” is to be understood to refer to a material that can exist in at least two phase states: a solid phase state and a softened or even flowable phase state. While not so required, a reconfigurable material can be reconfigured into a softened or flowable state by heating and/or at least partially melting the reconfigurable material.

As used herein, the term “optical beam” is to be understood to refer to a beam of electromagnetic energy or light that is capable of being focused to direct energy to one or more valving materials or adjacent absorbing regions that react with the optical beam. In one aspect of the invention, the optical beam is a laser beam that can be a component of a compact disk (“CD”) or digital video disk (“DVD”) read or read/write head.

As used herein, the term “thermally coupled” refers to the spatial relationship between valving material(s) and optically activatable material(s). Thermally coupled materials include materials that are admixed together, in contact at an interface, or spatially close enough so that temperature variation of one material exposes the other material to at least some of that temperature change. For example, by energizing an optically activatable material such that it generates heat, that heat can be transferred to the valving material to cause the valving material to change in configuration. In some embodiments, the optically activatable material is part of the valving material, e.g., an admixture including blends or solutions, and in other embodiments, the valving material is discrete from the optically activatable material, e.g., layers of material or proximate locations. Further, the term “thermally coupled” does not infer that actual thermal coupling must be present at all times, only that thermal coupling occurs when one of the two materials experiences a change in temperature and causes the other material to experience at lest part of that temperature change. Typically, these are significant changes in temperature that will cause a physical property of the valving material to become modified, e.g., change shape, become softened, etc.

As used herein, the term “microfluidics” and “microfluid” are to be understood to refer to fluids manipulated in systems that confine the fluids within geometric channels, passages, or reservoirs having at least one dimension less than about 1 mm. Similarly, the terms “microfluidic channel,” or “microchannel” are to be understood to refer to channels having at least one dimension less than about 1 mm.

When referring to fluids such as “liquids,” it is to be understood that not all constituents of the liquid are necessarily in liquid form. For example, blood is considered to be a liquid, even though it has solid cell constituents suspended therein. Liquid emulsions and microemulsions are also considered liquids, even though multiple liquids are present.

As used herein, the term “flow state” of a fluid channel is to be understood to refer to a state of the channel being open or closed to flow of a fluid through the channel. For example, a channel with a closed flow state will not allow flow of fluid through the channel. Conversely, a channel with an open flow state will allow flow of fluid through the channel. An open flow state can include a configuration in which a channel is only least partially open to flow of fluid.

The various channels, microchannels, and/or reservoirs utilized in various test coupons with which the present invention can be formed in the coupon in a variety of manners. In one embodiment, these features can be machined in a surface of a disk using conventional milling techniques. After milling, a covering, such as a thin polymer film, can be applied over each channel and/or reservoir to enclose the respective channel and/or reservoir. In addition to this method, it is contemplated that the geometric features of the test coupons can be formed in a variety of manners known to those having ordinary skill in the art including but not limited to injection molding, embossing, sintering, etc.

It has been recognized that it would be advantageous to develop a reliable, cost-effective system for effectively controlling fluid flow through channels at the microfluidic level. The present invention provides valves and valving systems that can be utilized to control the flow of fluids in or on a body or coupon from one location of the body or coupon to another. While not so required, the valves and valving systems of the present invention can be incorporated into rotational platforms that utilize microfluidic test coupons that are similar in appearance to CD-ROMs or DVDs. The valves and valving systems of the present invention can be used to controllably release fluids from one section of the test coupon without requiring that the valves be wired to any particular circuitry, and without requiring that the valves be contacted by any physical device.

In accordance with specific embodiments, the present invention provides a microfluidic device including a microfluidic coupon and at least one fluid channel associated with the microfluidic coupon. The fluid channel can provide a path for fluid flow from one portion of the coupon to another portion of the coupon. A quantity of reconfigurable valving material can be positioned within the fluid channel and can be thermally coupled to an optically activatable material operable to absorb energy from an optical beam when the optically activatable material is exposed to the optical beam to at least partially soften at least one component of the valving material to allow reconfiguration of the valving material to switch a flow state of the fluid channel.

In accordance with another aspect of the invention, a method of switching a flow state of a fluid channel is provided, including the steps of exposing to an optical beam an optically activatable material which is thermally coupled to a quantity of reconfigurable valving material disposed within the fluid channel, thereby changing at least a portion of the valving material to a softened or flowable state; and reconfiguring the valving material to switch a flow state of the fluid channel. The step of reconfiguring the valving material to switch the flow state of the fluid channel can include the step of switching the flow state from a closed state to an open state, or of switching the flow state from an open state to a closed state.

In accordance with another aspect of the invention, a method of forming a microfluidic test coupon is provided, including the steps of establishing at least one fluid channel on or in the test coupon; and forming a switchable valve in the fluid channel by positioning a valving material therein, wherein the valving material is thermally coupled to an optically activatable material.

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

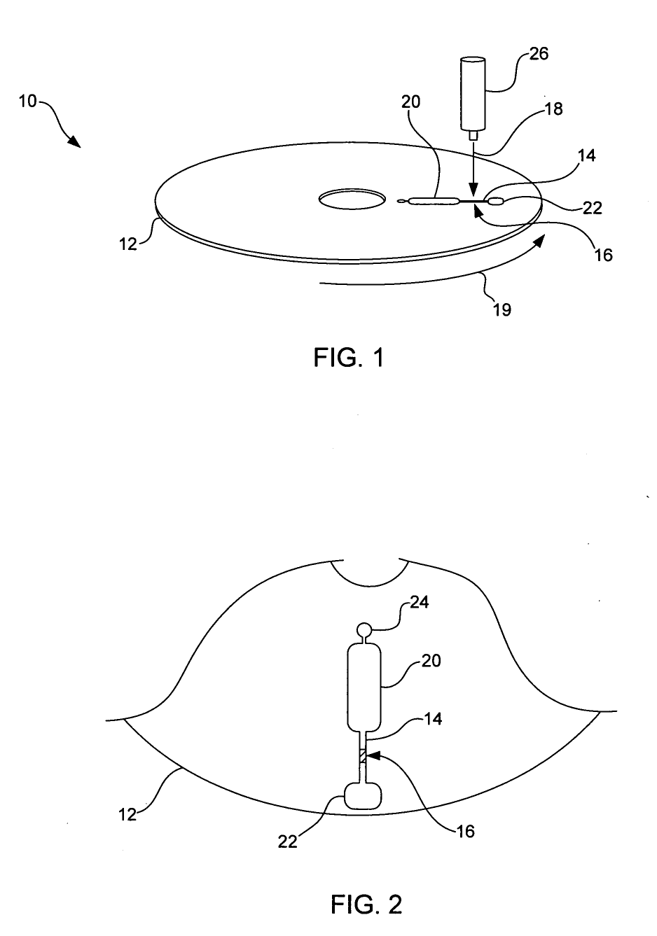

As shown generally in FIGS. 1 and 2, in one aspect of the invention, a microfluidic device 10 is provided that can include a microfluidic coupon 12. At least one fluid channel 14 can be associated with the microfluidic coupon and can be configured to provide a path for fluid flow from one portion of the coupon (e.g., fluid reservoir 20) to another portion of the coupon (e.g., reservoir 22). A quantity of reconfigurable valving material 16 can be disposed within the fluid channel although it may not be detectable in all of the figures. In addition, in some embodiments, the valving material can include an optically activatable component material operable to increase a temperature of the valving material when exposed to an optical beam 18 generated from an optical beam generator 26. In this manner, the valving material can at least partially melt to allow reconfiguration of the valving material to switch a flow state of the fluid channel, either from an open state to a closed state or from a closed state to an open state.

The test coupon 12 can include a fluid reservoir 20 in which a fluid (not shown) can be stored prior to mixing the fluid with another fluid, reactant, chemical composition, etc. Fluid channel 14 can fluidly couple the fluid reservoir with reservoir 22 which can include, for example, the other fluid or reactant with which the fluid is to be mixed or added. As will be appreciated, the valving material 16 (more fully appreciated in FIG. 2) can be disposed within the fluid channel to serve, in the embodiment shown, to block or close the channel to flow of the fluid. Thus, in the embodiment shown, the fluid in the reservoir will not flow past the valving material unless or until the valving material is removed from blocking or obstructing the channel.

When the valving material 16 is not blocking the channel 14, rotation of the test coupon 12 (as shown, for example, by directional indicator 19 in FIG. 1) would apply a centripetally-generated inertial force to the fluid stored within the fluid reservoir 20, causing the fluid to flow outward from the center of the test coupon and into the reservoir 22. While not required, a vent 24 can be located “upstream” of the reservoir 20, as illustrated in FIG. 2, to provide a vented configuration behind the fluid to allow unrestricted flow of the fluid when the channel 14 is in an open flow state.

The configuration of the fluid reservoir 20, fluid channel 14, fluid reservoir 22, vent valve 24, etc., are presented to provide a more complete understanding of the present invention and do not in any manner limit incorporation of the present invention into any particular system or application. Thus, while the valving systems of the present invention are shown, described, and used in connection with microfluidic test coupons, it is to be understood that the valves are not so limited and can be incorporated into a variety of testing, processing, manufacturing systems, etc., that can benefit from optically activatable valves. For example, the coupons shown in FIGS. 1 and 2 use centripetal force generated by spinning of the coupons. Other forces can also be used to drive fluid, including gravity, thermally generated forces, piezoelectrically generated forces, pneumatics, electrokinetic forces, etc.

The fluid channel 14 shown can be of a variety of sizes and configurations, and in one embodiment is a microchannel that is generally less than about 1 mm, and can be as small as about 5 μm or less, along at least one dimension of the channel.

The reconfigurable valving material 16 used in the present invention can take a variety of forms. In one aspect of the invention, the valving material can be a fusible wax or a gel that at least partially melts when exposed to an optical beam such as that generated by optical beam generator 26 in FIG. 1. In this aspect of the invention, paraffin wax or a similar material can be used and can be at least partially melted by a variety of optical beams. As optical beams can vary in wavelength and magnitude, the choice of valving material can be dictated by the optical beam used.

In another aspect of the invention, the valving material 16 can include a softenable or meltable material, such as paraffin wax, with an optically activatable material carried therein. Examples of optically activatable materials include, without limitation, optically absorbing materials that absorb energy from an optical beam when exposed thereto and become heated as a result. These are often referred to as absorber compositions, e.g., IR absorbers, UV absorbers, visible light absorbers, etc. Optically absorbing materials suitable for use in the present invention include, without limitation, near infrared dyes produced by American Dye Source, Inc., under the trade names ADS775PI, ADS775PP and ADS780HO. These dyes are particularly suited for use with electromagnetic energy beams with a wavelength of approximately 780 nm. This is approximately the wavelength utilized by “CD” optical disks and the Optical Pickup Units (OPUs) that read and write to these disks.

In one aspect of the invention, the reconfigurable valving material 16 can include a material that exothermically reacts when exposed to the optical beam 18. In this manner, the heat generation resulting from exposure to the optical beam is greater than that generated only by absorption of energy from the optical beam. That is, exposure of the valving material to the optical beam can result in an exothermic reaction taking place within the valving material, in effect leveraging or multiplying the heat generation in the valving material over that produced by absorption of optical energy only. In this aspect of the invention, a carrier material that may not be sufficiently softened or melted when exposed to an optical beam of a particular wavelength or magnitude can be softened or melted by way of the additional energy produced in the exothermic reaction. One example of a material suitable for use in generating an exothermic reaction includes, without limitation, nitrocellulose.

In one aspect of the invention, the reconfigurable valving material 16 can be positioned next to a solid surface (not shown) that absorbs energy when exposed to the optical beam 18. In this manner, the heat absorbed by the surface serves to heat the optically activatable material conductively to change its state. One example of such a configuration would be a black surface that readily absorbs visible wavelengths to thus increase its temperature, and this energy can be conductively transferred to the juxtaposed valving material.

In the aspects of the invention shown in the figures, the valving material 16 is shown disposed within the fluid channel 14 (the “primary fluid channel”) in which fluid flow is controlled by the valving material. It is to be understood, however, that the valving material can also be disposed in a secondary fluid channel (not shown) that is in fluid communication with the primary fluid channel. In this manner, the valving material can control flow through the primary fluid channel without physically contacting the fluid flowing through the primary fluid channel. For example, in one aspect of this embodiment, the primary and secondary fluid channels can collectively define a closed system, with the secondary fluid channel providing a vent to the primary fluid channel. In the event the secondary fluid channel is open, it can provide a vent for the primary fluid channel to thereby allow fluid to flow through the primary channel. In the event the secondary fluid channel is closed, it may not serve as a vent to the primary fluid channel, and fluid will be restricted from flowing through the primary fluid channel due to the lack of gasflow ahead of or behind the fluid (e.g., lack of aspiration or venting of the primary fluid channel). This embodiment of the invention can be utilized to control flow of fluid through the primary fluid channel by disposing the valving material in a vent channel either downstream or upstream of the desired fluid flow path. In either of the downstream or upstream configurations, the valving material can be utilized to control flow of the fluid without requiring that the valving material contact the fluid, thereby reducing risk of contamination of the fluid and/or potential compromise of testing or manufacturing processes utilizing the fluid.

It is to be noted that when referring to the reconfigurable valving material 16, reference is made to softening or melting of the material. When softening, pressure within the system can be used to remove or alter the shape of the softened material to reconfigure the shape of the valve. Alternatively, the reconfigurable valving material can be melted or partially melted so that at least a portion of the material is removed from its original location. Either embodiment is within embodiments of the present invention.

The optical beam generator 26 associated with the microfluidic device 12 can be of a variety of types known to those having ordinary skill in the art, and can be varied or adapted according to the type of valving material 16 used. When the valving material used has a relatively low softening or melting point, it has been found that a laser beam of the type often found in CD-ROM or DVD read or read/write heads produces sufficient heat, when contacting the valving material, to at least partially melt the valving material to a degree sufficient to switch a flow state of the fluid channel 14. This is particularly true when used with appropriately selected absorber antennas that are heated when interacting with an optical beam having an appropriately selected wavelength and/or power level.

As the valving material 16 of the present invention need only be exposed to an optical beam, the valving material can be installed on or in the test coupon 12 in an isolated state, and need not include circuitry, mechanical linkages, etc., that can greatly increase the complexity and cost of conventional valving systems. Thus, once a test coupon has been provided with the fluid necessary for a particular test or application, and the valving material has been installed in the appropriate location on the disk, the disk can be rotated by a testing apparatus and the valving material will restrain the fluid from flowing through the channel. When it is desired to release the fluid to flow to the reservoir 22, the optical beam generator 26 can be activated, by remote means if desired, and the valving material can be melted while the test coupon is rotating. This feature is advantageous over many conventional valving systems in that the test coupon need not be brought to a static state in order to manipulate the valving mechanism.

The present valving system thus allows for opening or closing the channel 14 to flow of the fluid (not shown) stored in reservoir 20 by remote means, obviating the need for an operator to manually manipulate any structure on the disk or coupon. This feature also advantageously does not utilize that sophisticated circuitry (which might otherwise utilize an electric connection while the test coupon is rotated) be connected to the valving mechanism.

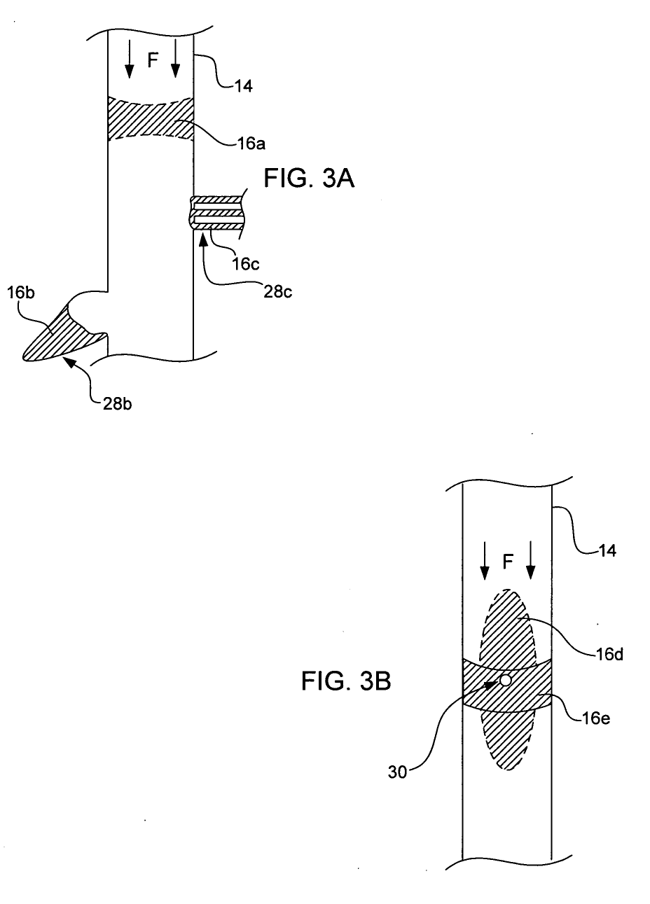

Turning now to FIGS. 3A and 3B, it can be seen that the present invention provides a variety of ways of configuring and switching the flow state of fluid channel 14. In the embodiment shown in FIG. 3A, valving material 16a is initially installed in a “closed” configuration, e.g. a condition that results in the flow state of the channel being closed. As will be appreciated, as fluid “F” is located upstream of the valving material, it is prohibited from flowing past the valving material while the material is in the initial, closed configuration. After the valving material 16a has been softened or melted, fluid “F” will flow downstream pushing the valving material ahead of the fluid. In one embodiment, the valving material (now in position 16b) will be captured in valving material fluid trap 28b or 28c. Fluid trap 28b is configured in a “cul de sac” configuration into which the valving material 16b can be swept and collected after the valving material is transformed into the softened, flowable, or melted state. Valving material fluid trap 28c is a series of small capillary tubes in fluid communication with the channel 14 that can wick the valving material 16c away from the channel 14 while the valving material is in the softened, flowable, or melted state. In alternate embodiments, the capillary tubes may be at or proximate to the initial the location of the valving material.

Thus, in the embodiments shown in FIGS. 3A, the present invention provides a system for removing the valving material from the fluid channel 14 to allow the fluid “F” to flow unobstructed through the channel. It is contemplated however, that the valving material can also be simply pushed to the side of the channel by the flowing fluid “F” without being removed from the channel.

In the embodiment illustrated in FIG. 3B, the valving material 16d is shown in an initial, “open” configuration, e.g. a condition that results in the flow state of the channel being open. As will be appreciated, fluid “F” is free to flow around the valving material 16d when in this initial configuration. After melting, or otherwise becoming softened or flowable, the valving can be reconfigured into the closed configuration shown at 16e, such as by surface tension, which switches the channel 14 to a closed flow state. In this embodiment, the valving material can be held or pinned within the channel via pin 30 to aid in retaining the valving material in position lengthwise along the channel when the valving material is in the melted, flowable state. Due to the pressure applied by the flowing fluid “F”, the valving material can be forced into the second, closed configuration by simply melting the valving material and allowing the flowing fluid to force the valving material into the closed configuration.

While it is anticipated that the present invention can be utilized in a variety of testing, processing, and/or manufacturing regimes, no specific preferred regime is detailed herein, as it is believed that those of ordinary skill in the art can readily incorporate the present invention into a variety of such regimes. In particular, it is contemplated that the present invention can be advantageously incorporated into testing regimes that utilize multiple fluid reservoirs, testing chambers, microchannels, reagents, etc., to perform multiple stages of tests, various flow sequencing events, etc., as would occur to one having ordinary skill in the art. In this manner, it is contemplated that the present invention can be particularly effective in performing testing requiring or benefiting from flow sequencing events which move fluids between different sections of the test coupon at different time intervals.

The mechanism used to rotate or spin the centrifugation coupons shown in FIGS. 1 and 2 of the present invention is not shown in the figures; it being understood that those having ordinary skill in the art can devise numerous rotational devices capable of rotating the present centrifugation coupons at rotational velocities suitable for the present methods. Additionally, other methods of moving fluid other than centripetal or centrifugal force can be used in other embodiments, e.g. gravity, thermal or piezoelectric jetting, pneumatics, electrokinetic forces, etc.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A microfluidic device, comprising:
(a) a microfluidic coupon;
(b) at least one fluid channel associated with the microfluidic coupon configured to control fluid flow from one portion of the coupon to another portion of the coupon; and
(c) a quantity of reconfigurable valving material disposed within the fluid channel, the valving material thermally coupled to an optically activatable material operable to increase a temperature of the valving material when the optically activatable material is exposed to an optical beam to at least partially soften at least one component of the valving material to allow reconfiguration of the valving material to switch a flow state of the fluid channel.

2. The device of claim 1, wherein the optically activatable material is an optically absorbing antenna material.

3. The device of claim 1, wherein the optically activatable material includes a material that exothermically reacts to exposure to the optical beam.

4. The device of claim 1, wherein the reconfigurable valving material initially creates a closed flow state in the channel.

5. The device of claim 4, further comprising at least one valving material trap, disposed downstream from an initial location of the valving material, the material trap being configured to receive released valving material downstream from the initial location after the flow state of the fluid channel has been switched to an open flow state.

6. The device of claim 1, further comprising at least one capillary tube valving material trap, disposed at or downstream from an initial location of the valving material, the material trap being configured to wick released valving material from the initial location after the flow state of the fluid channel has been switched to an open flow state

7. The device of claim 1, wherein the reconfigurable valving material initially creates an open flow state in the channel.

8. The device of claim 1, further comprising an optical beam generator associated with the microfluidic device, the optical beam generator being operable to provide the optical beam to partially soften or to melt the valving material.

9. The device of claim 8, wherein the optical beam generator is a laser beam generator.

10. The device of claim 9, wherein the laser beam generator is a component of an optical disk read or read/write head.

11. The device of claim 1, wherein the fluid channel is fluidly coupled to a second fluid channel to operably control fluid flow through the second fluid channel.

12. The device of claim 1, wherein the valving material and the optically activatable material are thermally coupled as an admixture.

13. The device of claim 1, wherein the valving material and the optically activatable material are thermally coupled by adjacent positioning.

14. A method of switching a flow state of a fluid channel, comprising the steps of:
(a) exposing to an optical beam an optically activatable material thermally coupled to a quantity of reconfigurable valving material disposed within the fluid channel, thereby changing at least a portion of the valving material to a softened or flowable state; and
(b) reconfiguring the valving material to switch a flow state of the fluid channel.

15. The method of claim 14, wherein the reconfigurable valving material comprises a fusible gel or wax.

16. The method of claim 14, wherein the reconfigurable valving material includes an optically activatable material.

17. The method of claim 14, wherein the reconfigurable valving material includes a material that exothermically reacts to exposure to the optical beam.

18. The method of claim 14, wherein the step of reconfiguring the valving material to switch a flow state of the fluid channel includes the step of switching the flow state from a closed state to an open state.

19. The method of claim 14, wherein the step of reconfiguring the valving material to switch a flow state of the fluid channel includes the step of switching the flow state from an open state to a closed state.

20. The method of claim 14, wherein the optical beam is a laser beam.

21. The method of claim 20, wherein the laser beam is a component of an optical disk read or read/write head.

22. The method of claim 14, wherein the fluid channel is fluidly coupled to a second fluid channel and wherein the step of reconfiguring the valving material controls a flow state of the second fluid channel.

23. The method of claim 14, further comprising the step of trapping the valving material in a valving material trap.

24. The method of claim 14, wherein the valving material and the optically activatable material are thermally coupled as an admixture.

25. The method of claim 14, wherein the valving material and the optically activatable material are thermally coupled by adjacent positioning.

26. A method of forming a microfluidic test coupon, comprising the steps of:
(a) establishing at least one fluid channel on or in the test coupon; and
(b) forming a switchable valve in the fluid channel by disposing a valving material therein, said valving material being thermally coupled to an optically activatable material.

27. The method of claim 26, wherein the optically activatable material is an optically absorbing material.

28. The method of claim 26, wherein the optically activatable reconfigurable valving material includes a material that exothermically reacts to exposure to an optical beam.

29. The method of claim 26, wherein the step of forming a switchable valve in the fluid channel includes the step of forming a closed valve in the fluid channel that is openable upon interaction with an optical beam.

30. The method of claim 26, wherein the step of forming a switchable valve in the fluid channel includes the step of forming an open valve in the fluid channel that is openable upon interaction with an optical beam.

31. The method of claim 26, further comprising forming a valving material trap configured to trap the valving material when the switchable valve is switched

32. A microfluidic device, comprising:
(a) a microfluidic coupon;
(b) means for driving fluid flow from one portion of the coupon to another portion of the coupon; and
(c) means for optically controlling a microvalve to allow reconfiguration of the microvalve to switch a flow state of a fluid channel associated with the microfluidic coupon.

33. The device of claim 32, wherein the means for optically controlling further comprises means for optically reconfiguring a valving material associated with the microvalve.

34. The device of claim 33, wherein the means for optically reconfiguring further comprises means for absorbing radiation with the valving material.

35. The device of claim 33, wherein the means for optically reconfiguring further comprises means for exothermically reacting the valving material.

37. The device of claim 32, further comprising means for trapping the valving material.
